(19) United States
(12) Patent Application Publication
(10) Pub. No.: US 2026/0010904 A1
(43) Pub. Date: Jan. 8, 2026

(54) SYSTEMS AND METHODS FOR PROVIDING ELECTRONIC DISBURSEMENTS

(71) Applicant: Wells Fargo Bank, N.A., San Francisco, CA (US)

(72) Inventors: Misung Kim, San Francisco, CA (US); Prafullata Diwate, San Francisco, CA (US)

(21) Appl. No.: 18/766,109

(22) Filed: Jul. 8, 2024

(51) Int. Cl. G06Q 20/40; G06Q 20/02; G06Q 20/38

(52) U.S. Cl. CPC G06Q 20/4014; G06Q 20/023; G06Q 20/3825

(57) ABSTRACT

Systems, apparatuses, methods, and computer program products are disclosed for using a mobile driver's license (mDL) to enhance electronic disbursement staging. An example method includes receiving a disbursement initiation request from a target recipient, wherein the disbursement initiation request comprises identifying (i) disbursement data, (ii) a recipient mDL, and (iii) a recipient device. The example method further incudes verifying, based on the disbursement initiation request, authenticity of the mDL. The example method further includes, in response to verifying the authenticity of the mDL, selecting, using a risk determination machine learning model, a secondary authentication protocol. The example method further includes authenticating, based on the secondary authentication protocol, the target recipient. The example method further includes receiving, from the recipient device, disbursement preference data, and staging a disbursement event using the disbursement preference data.

### BACKGROUND

Transferring funds via mobile computing devices allows for efficient handling of payments such as payroll, vendor payments, and government benefits. However, conventional electronic disbursement systems and techniques exhibit numerous drawbacks, inefficiencies, and limitations.

### BRIEF SUMMARY

Conventional electronic disbursement systems, such as those provided by banks or financial institutions, enable the transfer of funds to recipients and management of reimbursement processes. These systems typically support various payment methods, including direct deposit, electronic funds transfer (EFT), and automated clearing house (ACH) transfers. However, disbursing entities continue to struggle with streamlining the disbursement process efficiently and effectively, particularly in reducing the manual labor required to authenticate recipients. Additionally, conventional electronic disbursement methods are prone to human errors which may be costly and time-consuming to resolve (e.g., incorrect payment amounts or misdirected funds), potential delays in disbursement, and often lack robust security measures to ensure the safe disbursement of funds.

For example, disbursing entities employing conventional electronic disbursement systems for payroll typically adhere to a structured sequence of operations. Initially, the payroll department of the disbursing entity initiates the payment process by uploading a file comprising employee payment details (e.g., bank account numbers, corresponding payment amount, etc.) to the entity's internal banking system. Subsequently, the banking system may perform a verification step, wherein the uploaded file is scrutinized for errors and recipient details are validated against existing records. Should any discrepancies be identified, the payroll department is required to manually rectify such discrepancies and re-upload the corrected file. Following successful verification, the banking system processes the payments through an established financial network, effectuating the transfer of funds from the entity's account to the respective employees' bank accounts. Evidently, the aforementioned verification step necessitates manual intervention for the identification and correction of errors, which can impede the payment process and impose additional manual burdens on personnel. As such, there is a unique need for a technical solution that automates and streamlines the disbursement process by minimizing the manual verification of recipients. Given that recipient verification often must occur in near-real-time and in many parallel instances at scale, especially to meet time-sensitive disbursement deadlines, a systematic and computer-based implementation is necessary to mitigate delays and risks associated with manual verification measures. In other words, there exists an underlying technical necessity for systems that are able to autonomously provide this capability.

Example implementations described herein provide a technical solution to this technical problem, and in doing so overcome the challenges that arise from the manual verification of recipients during the disbursement process. In contrast to conventional techniques for verifying recipients during a disbursement process, example embodiments described herein comprise an electronic disbursement staging system 102 configured to utilize a mobile driver's license (mDL) associated with a target recipient to authenticate the respective target recipient. In this regard, the electronic disbursement staging system may be employed to remotely authenticate the target recipient based on a respective mDL associated with the target recipient. As will be described in greater detail below, utilizing mDLs that have been issued by legally entitled entities (e.g., government agencies) adds an additional layer of trust to each disbursement facilitated by the electronic disbursement staging system 102. Furthermore, utilizing mDLs to authenticate and/or verify target recipients ensures that only intended parties are receiving the disbursement amount associated with a particular disbursement event.

Furthermore, example implementations described herein are not limited solely to employee disbursement scenarios and may also be extended to non-employee and employer situations, wherein employers may disburse payments to target recipients for whom pre-existing data is not available for verification purposes. In such instances, the example embodiments described herein facilitate the seamless provision of disbursements whilst eliminating the need for pre-existing recipient data. This versatile feature underscores the applicability of the technical solution across diverse disbursement contexts, thereby enhancing its utility and value proposition in various operational settings.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to enhance electronic disbursement staging.

FIG. 2 illustrates a schematic block diagram of example circuitry embodying a system device that may perform various operations in accordance with some example embodiments described herein.

FIG. 3 illustrates an example flowchart for enhancing electronic disbursement staging, in accordance with some example embodiments described herein.

FIG. 4 illustrates an example flowchart for receiving a disbursement initiation request, in accordance with some example embodiments described herein.

FIG. 5A illustrates an example flowchart for verifying authenticity of the mobile driver's license (mDL), in accordance with some example embodiments described herein.

FIG. 5B illustrates another example flowchart for authenticating the target recipient in an instance in which the mDL was verified as authentic, in accordance with some example embodiments described herein.

FIG. 6 illustrates another example flowchart for authenticating the target recipient based on the secondary authentication protocol, in accordance with some example embodiments described herein.

FIG. 7 illustrates another example flowchart for staging a disbursement event using the disbursement preference data.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “electronic disbursement staging” may refer to the preparatory processes and steps (e.g., verification of the target recipient, accounting system integration, batching and scheduling of disbursements, implementation of security measures, and performing real-time monitoring and reporting) involved in readying electronic disbursements for transfer from a disbursing entity to a target recipient for a particular disbursement event.

The term “disbursement event” may refer to an occurrence where a disbursing entity executes the transfer of funds and/or other resources to a target recipient, in accordance with a predefined set of terms and conditions. In particular, the disbursement event may encompass all activities associated with the authorization, processing, verification, and completion of the financial disbursement, including the validation of recipient credentials, the confirmation of disbursement data, and the secure transmission of funds to the designated account of the target recipient. It will be understood that the disbursement event is governed by applicable regulatory and contractual frameworks, ensuring compliance with legal, financial, and security standards.

The term “disbursing entity” may refer to an organization, institution, or individual responsible for distributing funds and/or resources to a target recipient. For example, disbursing entities may include businesses, government agencies, non-profits, and other institutions that manage and execute payments for purposes such as payroll, vendor payments, grants, and/or other benefits.

The term “target recipient” may refer to an individual or an entity designated to receive funds from a disbursing entity. A target recipient may be an employee, vendor, contractor, beneficiary, or any other party entitled to receive a disbursement from the disbursing entity.

The term “user” may refer to an individual authorized to engage in the verification, authorization, and processing of disbursements for a disbursement event. The user may be vested with the responsibility to ensure that all disbursement requests comply with established protocols and regulatory requirements. For example, the user may perform tasks related to the validation of recipient data, the review of the disbursement initiation request, and the final authorization required to stage a disbursement event.

The term “disbursement initiation request” may refer to a request submitted by a target recipient and/or user to a disbursing entity, signaling the intent to stage a disbursement event.

The term “submission channel” may refer to the designated platform, interface, or method employed by a recipient or a user to initiate and transmit a disbursement initiation request to a disbursing entity. Examples of a submission channel may include web portals, mobile applications, integrated systems, and/or the like utilized for the submission of disbursement initiation request.

The term “priority submission channel” may refer to a submission channel that is preferred and designated by a disbursing entity as a high-priority pathway for submitting disbursement initiation requests. In particular, the priority submission channel may be characterized by enhanced processing speed, reliability, and security, reflecting the disbursing entity's preference for its usage.

The term “standard submission channel” may refer to any submission channel used for submitting disbursement initiation requests that does not meet the criteria to be classified as a priority submission channel. In particular, a standard submission channel may be considered a default pathway that involves standard processing and a standard priority level, as determined by a particular disbursing entity.

The term “risk determination machine learning model” may refer to an artificial intelligence (AI) system designed to evaluate and predict the level of risk associated with a disbursement initiation request. The risk determination machine learning model may be a supervised learning model (e.g., logistic regression, decision tree, random forest), an unsupervised learning model (e.g., clustering algorithm, anomaly detection algorithm), and/or a reinforcement learning model.

### System Architecture

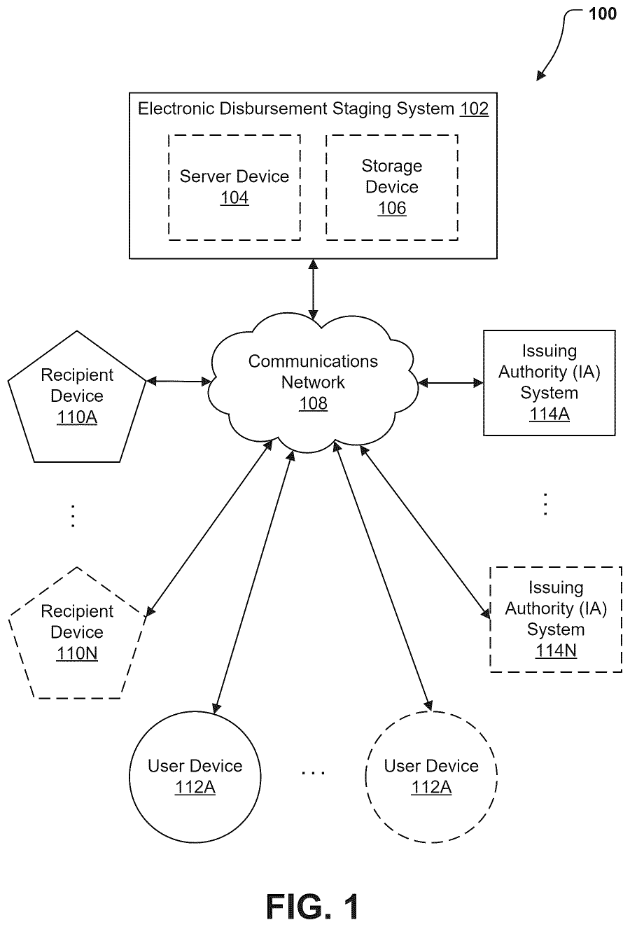

Example embodiments described herein may be implemented using any of a variety of computing devices or servers. To this end, FIG. 1 illustrates an example environment 100 within which various embodiments may operate. As illustrated, an electronic disbursement staging system 102 may receive and/or transmit information via communications network 108 (e.g., the Internet) with any number of other computing devices and/or computing systems, such as one or more of recipient devices 110A-110N, user devices 112A-112N, and/or issuing authority (IA) systems 114A-114N. Although server device 104 and storage device 106 are described in singular form, some embodiments may utilize more than one server device 104, more than one storage device 106, and/or the like. The one or more recipient devices 110A-110N and the one or more user devices 112A-112N may be embodied by any computing devices known in the art. The one or more recipient devices 110A-110N and the one or more user devices 112A-112N need not themselves be independent devices but may be peripheral devices communicatively coupled to other computing devices. The one or more recipient devices 110A-110N may include laptops, tablets, phones, whereas the one or more user devices 112A-112N may be a device associated with a disbursing entity that performs operations related to electronic disbursement.

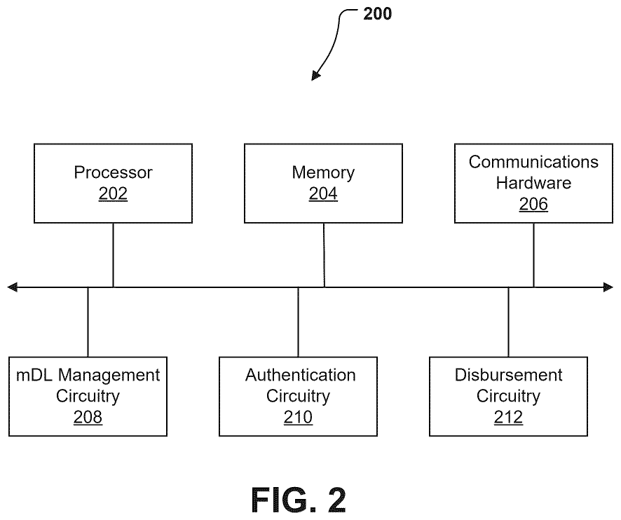

The electronic disbursement staging system 102 may be implemented as one or more computing devices or servers, which may be composed of a series of components. These components of server device 104 may be physically proximate to the other components of the electronic disbursement staging system 102, while other components are not. The server device 104 may receive, process, generate, and transmit data, signals, and electronic information to facilitate the operations of the electronic disbursement staging system 102. Particular components of the electronic disbursement staging system 102 are described in greater detail below with reference to apparatus 200 in connection with FIG. 2.

In some embodiments, the electronic disbursement staging system 102 further includes a storage device 106 that comprises a distinct component from other components of the electronic disbursement staging system 102. Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the electronic disbursement staging system 102. Storage device 106 may store information relied upon during operation of the electronic disbursement staging system 102, such as recipient attribute data that may be used by the electronic disbursement staging system 102, data and documents to be analyzed using the electronic disbursement staging system 102, or the like. In addition, storage device 106 may store control signals, device characteristics, and access credentials enabling interaction between the electronic disbursement staging system 102 and one or more of the recipient devices 110A-110N, and/or user devices 112A-112N.

In some embodiments, the electronic disbursement staging system 102 may be configured to facilitate the execution of one or more processes related to authenticating an mDL associated with a target recipient. As a non-limiting example, the electronic disbursement staging system 102 may be configured to verify a target recipient based on a respective mDL associated with the target recipient before staging a disbursement event. In this regard, the electronic disbursement staging system 102 may be configured to store, integrate with, manage, and/or utilize one or more mDLs (and/or data related to the one or more mDLs (e.g., mDL identifying information, cryptographic key information)) associated with a target recipient in order to facilitate the various operations described herein. As used herein, the term “mDL” covers various mobile (e.g., digital) identity credential types associated with a target recipient including mobile driver's licenses and mobile identification cards. An mDL may be an electronically managed data structure configured to be accessed, processed, and/or otherwise utilized by the electronic disbursement staging system 102 for various authentication processes.

In this regard, an mDL may be configured to store or point to (e.g., programmatically reference) various credential data associated with a target recipient including, but not limited to, personally identifiable information (PII) (e.g., given name, family name, name prefix, name suffix, driver's license number, social security number, administrative number), target recipient information (e.g., height, eye color, hair color, age, organ donor status, veteran status, gender information, sex information, race information, ethnicity information, target recipient portrait image data, target recipient signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the target recipient. Additionally, an mDL may be configured to store and/or point to various cryptographic key information (e.g., public key information used to identify the mDL, a corresponding target recipient device, and/or a corresponding target recipient) and/or originating IA data (e.g., cryptographic key information and/or identifying data associated with an originating IA).

An mDL may be issued (e.g., provisioned) to a target recipient by an IA system 114A associated with a particular IA. An IA may be an entity that is legally entitled (or otherwise recognized as the relevant authority) to issue credentials, such as driver's licenses and/or other identification cards. An IA system 114A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 114A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally, or alternatively, in some embodiments, an mDL may be administered, managed, employed, and/or otherwise utilized by the electronic disbursement staging system 102 in compliance with various standards set forth by the American Association of Motor Vehicle Administrators (AAMVA). Additionally, or alternatively, in some embodiments, an mDL may be administered, managed, employed, and/or otherwise utilized by the electronic disbursement staging system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a target recipient and may comprise and/or be associated with the same data as the legal credential. In some embodiments, an mDL associated with a target recipient may be stored in a storage device (e.g., a server system) of an IA system 114A and one or more portions of credential data related to the mDL may be retrieved in real time, or near-real time, during a transaction associated with the target recipient (e.g., an online transaction requiring target recipient verification, target recipient authentication, target recipient age verification, and/or the like). Additionally, or alternatively, once an mDL is issued to a target recipient by a respective IA (e.g., by way of a corresponding IA system 114A), the mDL may be stored locally on a recipient device associated with the target recipient (e.g., recipient device 110A) such that the mDL may be used without relying on a communications network (e.g., communications network 108). Additionally, or alternatively, in some embodiments, an mDL may be stored in a smart mobile wallet associated with the target recipient and managed by the electronic disbursement staging system 102, and the mDL may be accessed and/or utilized by the target recipient via the smart mobile wallet to execute various mDL-based transactions.

In some examples, an IA may provision an mDL to a particular recipient device (e.g., recipient device 110A) associated with a target recipient such that the mDL is associated with various recipient device identification data related to the particular recipient device (e.g., cryptographical identification data such as a public key). This may ensure that an mDL associated with a target recipient cannot be transferred to multiple devices without authorization by the IA system (e.g., IA system 114A) and used in fraudulent transactions. Furthermore, associating an mDL with a particular recipient device (e.g., recipient device 110A) also enables the electronic disbursement staging system 102 and/or an IA system of an IA (e.g., IA system 114A) to verify that the intended target recipient of the mDL is in possession of the mDL. Further still, associating an mDL with a particular recipient device (e.g., recipient device 110A) also ensures the safe transfer of sensitive credential data to and/or from the intended target recipient of the mDL. In various examples, a target recipient may store multiple copies of an mDL on multiple recipient devices (e.g., recipient devices 110A-110N). However, in such examples, each respective copy of the mDL may be cryptographically coupled to a respective recipient device by the IA system (e.g., IA system 114A) which provisioned the mDL. In this manner, each copy of the mDL can be independently verified against a respective recipient device to ensure that an mDL, or credential data associated with the mDL, cannot be transferred to unauthorized recipient devices.

An mDL may be associated with various mDL data security mechanisms used to ensure the validity of the mDL, authenticate an originating IA that issued the mDL, protect a target recipient's personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, target recipient signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding target recipient may not be disbursed a pending disbursement amount.

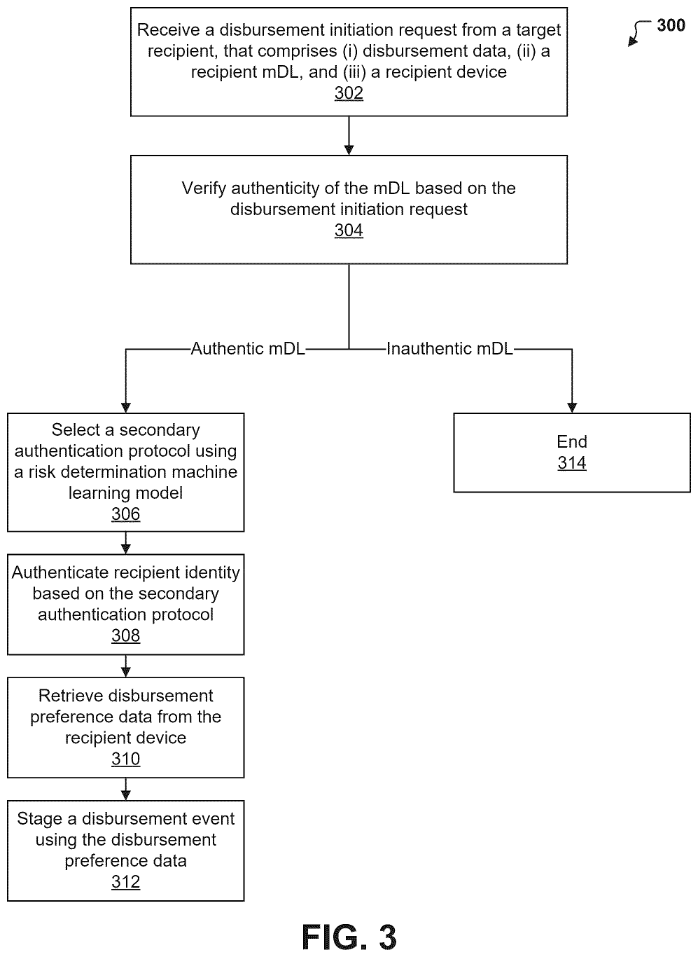

Additionally, an mDL may be associated with various cryptographic key information (e.g., public/private key pair information) that may be utilized by the electronic disbursement staging system 102 to authenticate an originating IA that issued the mDL, verify one or more portions of credential data associated with an mDL, and/or facilitate various mDL-based transactions (e.g., disbursement transactions, recipient authentication protocols, mDL data queries) for a target recipient associated with the mDL. For example, an IA associated with a respective IA system 114A may be associated with a unique public key that may be utilized by the electronic disbursement staging system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a target recipient by the electronic disbursement staging system 102 will be described in greater detail herein with reference to FIGS. 3-7

In some embodiments, the electronic disbursement staging system 102 further comprises and/or integrates with a storage device that comprises a distinct component from other components of the electronic disbursement staging system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Additionally, or alternatively, the storage device may host the software executed to operate the electronic disbursement staging system 102. Additionally or alternatively, the storage device may store information relied upon during operation of the electronic disbursement staging system 102, such as various target recipient data (e.g., recipient attribute data, recipient identification data), mDL data (e.g., cryptographical information, credential information), disbursing entity data (e.g., payment account data, recipient transaction data, product and/or service data), smart mobile wallet data (e.g., payment account data, payment card data, and/or the like associated with a target recipient), distribution data, logistical data, legal data, software application framework data, etc.), and/or the like configured in various data formats to be utilized by the electronic disbursement staging system 102. In addition, the storage device may store control signals, device characteristics, and/or access credentials enabling interaction between the electronic disbursement staging system 102 and/or one or more of the recipient devices 110A-110N or user devices 112A-112N.

### Example Implementing Apparatuses

The electronic disbursement staging system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-7. As illustrated in FIG. 2, the apparatus 200 may include processor 202, memory 204, communications hardware 206, mDL management circuitry 208, authentication circuitry 210, and disbursement circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and/or a target recipient and, in some embodiments, to receive an indication of user input and/or target recipient input. In this regard, the communications hardware 206 may comprise an interface, such as a display, and may further comprise the components that govern use of the interface, such as a web browser, mobile application, dedicated user device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises mDL management circuitry 208. In some embodiments, the mDL management circuitry 208 may be configured to facilitate the execution of one or more mDL authentication and/or IA authentication operations for a disbursing entity associated with the electronic disbursement staging system 102. Additionally, the mDL management circuitry 208 may utilize processor 202, memory 204, or any other hardware component included in the apparatus 200 to perform these operations, as described in connection with FIGS. 3-7 below. The mDL management circuitry 208 may further utilize the communications hardware 206 to gather data from, or transmit data to, a variety of sources (e.g., the user devices 112A-112N, the recipient devices 110A-110N, the IA systems 114A-114N, and/or any storage devices associated with the electronic disbursement staging system 102), and/or exchange data with a user. In some embodiments, the mDL management circuitry 208 may work in conjunction with the authentication circuitry 210 and/or the disbursement circuitry 212 in order to execute one or more of the methods described herein. For example, in some embodiments, the mDL management circuitry 208 may integrate with and/or otherwise leverage the authentication circuitry 210 to facilitate the authentication of a target recipient based on a respective mDL associated with the target recipient.

In various circumstances, an IA system (e.g., IA system 114A) that previously issued an mDL to a target recipient may periodically update credential data associated with the mDL (e.g., new target recipient contact information, updated credential restrictions, updated credential endorsements). As such, the mDL management circuitry 208 may be configured to retrieve and/or receive updated credential data associated with a target recipient's mDL from an IA system (e.g., IA system 114A) and facilitate the updating of the target recipient's mDL based on the updated credential data. For example, if an mDL associated with a target recipient is stored in a smart mobile wallet being managed by the electronic disbursement staging system 102, the mDL management circuitry 208 may be configured to receive updated credential data associated with the target recipient's mDL from the originating IA system (e.g., IA system 114A) and subsequently update the target recipient's mDL in the smart mobile wallet based on the updated credential data.

In some embodiments, the mDL management circuitry 208 may update an mDL stored on a recipient device (e.g., recipient device 110A). In such embodiments, the mDL management circuitry 208 may be configured to query one or more storage devices (e.g., server systems) associated with an IA system (e.g., IA system 114A) in order to retrieve current and/or updated credential data in response to one or more interactions with a recipient device interface associated with the smart mobile wallet. Additionally, or alternatively, the mDL management circuitry 208 may be configured to periodically query to one or more storage devices (e.g., server systems) associated with an IA system (e.g., IA system 114A) based on a predefined schedule (e.g., once a day, once a week, once a month, once every 90 days) in order to retrieve current and/or updated credential data associated with a target recipients' mDL.

In various examples, an IA (e.g., a branch of the DMV) associated with a respective IA system (e.g., IA system 114A) may enforce various mDL data freshness requirements associated with the mDLs the IA system provisions to target recipients. In this regard, an MSO associated with a respective mDL may indicate a technical validity period associated with the mDL (e.g., a 30-day validity period). As such, the mDL management circuitry 208 may utilize the technical validity period indicated by the MSO to ensure that the credential data associated with the mDL stored on a recipient device (e.g., recipient device 110A) is updated and/or current. For example, if the mDL management circuitry 208 determines that the technical validity period indicated by the MSO has expired, the mDL may be invalidated until the credential data associated with the mDL is refreshed (e.g., updated, verified) by the IA system 114A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver's license associated with the mDL).

For example, legal credentials (e.g., a driver's license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular target recipient's legal credential, yet the target recipient fails to have the legal credential (e.g., a corresponding physical credential) updated with said credential restrictions and/or credential endorsements. To address such problems, if the mDL management circuitry 208 determines that the technical validity period indicated by the MSO of the mDL has expired, the corresponding mDL may flag the mDL such that the mDL will fail various authentication protocols during an mDL-based transaction.

In this regard, the mDL management circuitry 208 may be configured to facilitate the resetting of the technical validity period indicated by the MSO of the mDL in conjunction with a corresponding IA system (e.g., IA system 114A). Additionally, or alternatively, the mDL management circuitry 208 may be configured to facilitate the updating and/or verification of the credential data associated with an mDL stored on a recipient device (e.g., recipient device 110A) each time the technical validity period associated with the MSO of the mDL is reset. This mDL data security mechanism ensures that the credential data associated with a target recipient's mDL is always accurate and up to date.

As described herein, an mDL may be associated with various cryptographic key information (e.g., public/private key pair information) that may be utilized by the electronic disbursement staging system 102 to authenticate an originating IA that issued the mDL, verify one or more portions of credential data associated with an mDL, and/or facilitate various mDL-based transactions (e.g., disbursement operations, target recipient authentication protocols, mDL data queries) for a target recipient associated with the mDL. In this regard, the mDL management circuitry 208 may be configured to generate and/or transmit an IA authentication request comprising a public key associated with an IA to a corresponding IA system 114A in order to verify that a particular mDL was indeed provisioned by the IA associated with the IA system 114A.

In some examples, an mDL may only comprise (e.g., store, point to) identifying information related to a particular IA such that the mDL management circuitry 208 may be configured to first obtain a public key associated with the IA from a corresponding IA system 114A based on the identifying information. Once the public key information associated with the IA is obtained, the mDL management circuitry 208 may be configured to generate an IA authentication request comprising the public key of the IA and transmit the IA authentication request to the IA system 114A (e.g., via the communications network 108). As such, the mDL management circuitry 208 may be configured to receive, from an IA system (e.g., IA system 114A) and in response to the IA authentication request, one or more portions of data indicating whether the IA is a bona fide IA and/or whether the mDL indeed originated from the IA.

Once the mDL management circuitry 208 confirms the validity of the IA and/or confirms that a particular mDL associated with a target recipient originated from the IA, the mDL management circuitry 208 may be configured to generate a digital token comprising cryptographical information (e.g., public key information) associated with the mDL and the target recipient. Additionally, in some embodiments, the cryptographical information associated with the mDL and comprised in the digital token may be recipient device identification data by which a recipient device (e.g., recipient device 110A) of the target recipient may be uniquely identified. In various examples, the mDL management circuitry 208 may generate and/or transmit the digital token to an IA system (e.g., IA system 114A) such that the IA system may decrypt the cryptographical information comprised in the digital token. In this manner, the IA system (e.g., IA system 114A) may authenticate (e.g., verify) one or more portions of credential data associated with the mDL and/or one or more portions of recipient device identification data associated with the recipient device (e.g., recipient device 110A). In this regard, the mDL management circuitry 208 may be configured to receive, from the IA system (e.g., IA system 114A) and in response to transmitting the digital token, one or more portions of data indicating whether the mDL and/or the recipient device (e.g., recipient device 110A) identified by the digital token is valid. Furthermore, in various examples, the mDL management circuitry 208 may be configured to receive, from the IA system (e.g., IA system 114A) and in response to transmitting the digital token, one or more portions of credential data associated with the mDL.

In some embodiments, the mDL management circuitry 208 may be configured to generate a digital token comprising cryptographical information (e.g., public key information) associated with an mDL and/or a recipient device (e.g., recipient device 110A) associated with a particular target recipient in response to an mDL authentication request associated with the particular target recipient. In some embodiments, the mDL authentication request may be a request to authenticate an mDL associated with the particular target recipient and thereby authenticate the identity of the particular target recipient for one or more mDL-based transactions. A respective mDL authentication request may comprise one or more of cryptographical information (e.g., public key information) associated with an mDL and/or a recipient device (e.g., recipient device 110A). Additionally, or alternatively, a respective mDL authentication request may comprise one or more desired data elements (e.g., one or more desired portions of credential data) associated with the mDL, location data, recipient profile data, recipient account data, social media data, smart mobile wallet identification data, recipient device identification data, and/or the like associated with the particular target recipient.

In various examples, an mDL validity response received from an IA system (e.g., IA system 114A) based on a digital token generated by the mDL management circuitry 208 may comprise the entirety of the credential data associated with the mDL of the particular target recipient. Additionally, or alternatively, in various other examples, an mDL validity response received from an IA system (e.g., IA system 114A) based on a digital token generated by the mDL management circuitry 208 may comprise a verification of the desired credential data associated with the mDL that was indicated by an mDL authentication request. Additionally, or alternatively, in various other examples, an mDL validity response received from an IA system (e.g., IA system 114A) based on a digital token generated by the mDL management circuitry 208 may comprise a verification of the recipient device identification data associated with the recipient device (e.g., recipient device 110A) of the particular target recipient. For example, the mDL validity response may verify that the recipient device currently associated with the mDL is the same (e.g., intended) recipient device that the mDL was originally provisioned to. In this manner, the electronic disbursement staging system 102 may be configured to confirm the validity of the mDL data of an mDL associated with a particular target recipient in order to authenticate the identity of the particular target recipient. Additionally, this enables the electronic disbursement staging system 102 to confirm whether the intended target recipient and/or recipient device (e.g., recipient device 110A) associated with the mDL is currently in possession of the mDL. These and other operations associated with the mDL management circuitry 208 will be described in further detail herein below with reference to FIGS. 3-7.

In addition, the apparatus 200 further comprises authentication circuitry 210. In some embodiments, the authentication circuitry 210 may be configured to facilitate the execution of one or more recipient authentication operations for a disbursing entity associated with the electronic disbursement staging system 102. Additionally, the authentication circuitry 210 may utilize processor 202, memory 204, to perform these operations, as described in connection with FIGS. 3-7 below. The authentication circuitry 210 may further utilize the communications hardware 206 to gather data from, or transmit data to, a variety of sources (e.g., the disbursing entity computing devices 106A-106N, the recipient devices 110A-110N, the IA systems 114A-114N, and/or any storage devices associated with the electronic disbursement staging system 102), and/or exchange data with a recipient and/or user. In some embodiments, the authentication circuitry 210 may work in conjunction with the mDL management circuitry 208 and/or the disbursement circuitry 212 in order to execute one or more of the methods described herein. For example, in some embodiments, the authentication circuitry 210 may integrate with and/or otherwise leverage the mDL management circuitry 208 to facilitate the verification and/or authentication of a target recipient based on a respective mDL associated with the target recipient.

Additionally, the authentication circuitry 210 may be configured to identify a smart mobile wallet associated with a target recipient and/or the like. For example, the authentication circuitry 210 may identify a smart mobile wallet associated with a target recipient based on attribute data associated with the target recipient. In some embodiments, recipient attribute data associated with a target recipient may comprise recipient profile data, recipient account data, recipient contact data, social media data, location data, and/or smart mobile wallet identification data associated with the target recipient.

In various examples, once the authentication circuitry 210 identifies a smart mobile wallet that is ostensibly associated with the target recipient, the authentication circuitry 210 may be configured to generate a recipient identification data request based on recipient attribute data associated with the target recipient. The authentication circuitry 210 may be configured to leverage the communications hardware 206 to transmit the recipient identification data request to the smart mobile wallet ostensibly associated with the target recipient. Furthermore, the authentication circuitry 210 may be configured to leverage the communications hardware 206 to receive recipient identification data from the smart mobile wallet ostensibly associated with the target recipient based on the recipient identification data request.

In various examples, the recipient identification data associated with a target recipient comprises cryptographical information associated with one or more of an mDL and/or a recipient device 110A associated with the target recipient. In some embodiments the cryptographical information associated with the mDL and/or the recipient device may be a public key of a public/private key pair, where the public key is provisioned to the target recipient by an IA upon issuance of the mDL. Such cryptographical information may be utilized by the electronic disbursement staging system 102 and/or an IA system (e.g., IA system 114A) associated with the IA that provisioned the mDL to verify and/or authenticate the mDL, one or more portions of desired mDL credential data, and/or the recipient device associated with the target recipient. In this regard, the authentication circuitry 210 may be configured to verify that the smart wallet ostensibly associated with the target recipient and/or the like is indeed associated with the target recipient and that the disbursement circuitry 212 may safely transmit and/or receive data (e.g., payment account data, transaction data) to and/or from the smart mobile wallet associated with the target recipient.

Additionally, or alternatively, in some embodiments, the authentication circuitry 210 may be configured to facilitate execution of secondary authentication of a target recipient in addition to authenticating the target recipient based on a corresponding mDL. In this regard, the authentication circuitry 210 may be configured to facilitate the execution of a second factor of authentication including one or more of facial recognition, voice recognition, and/or biometric authentication techniques (e.g., fingerprint recognition, retina recognition, iris recognition). For example, the authentication circuitry 210 may be configured to prompt a target recipient via a recipient device (e.g., recipient device 110A) to authenticate themselves via a second factor of authentication (e.g., biometric authentication based on fingerprint data) before allowing the target recipient to access a smart mobile wallet managed by the electronic disbursement staging system 102. Additionally, or alternatively, in various embodiments, the authentication circuitry 210 may be configured to prompt a target recipient via a recipient device (e.g., recipient device 110A) to authenticate themselves via a second factor of authentication (e.g., voice recognition) either prior to or subsequent to authenticating the target recipient based on an mDL associated with the target recipient.

Additionally, or alternatively, in some embodiments, the authentication circuitry 210 may be configured to employ one or more facial recognition techniques to authenticate a target recipient during a secondary authentication process. For example, authentication circuitry 210 may be configured to authenticate a target recipient by matching image data related to the target recipient's face that is captured in real time, or near-real time, (e.g., via a camera of a recipient device 110A) to recipient portrait image data associated with an mDL related to the target recipient. In this regard, the authentication circuitry 210 may be configured to generate an image matching score based on matching the image data of the target recipient's face captured in real time, or near-real time, to the recipient portrait image data associated with the target recipient's mDL.

As such, the authentication circuitry 210 may be configured to determine if an image matching score (e.g., a numerical value or the like) satisfies a respective image matching threshold (e.g., a numerical value or the like). The image matching score may satisfy the respective image matching threshold if the image matching score is greater than or equal to the respective image matching threshold (e.g., to within an error value of ±1%, ±5%, or any other number). In other examples, the image matching score (e.g., a numerical value or the like) may satisfy the respective image matching threshold (e.g., a numerical value or the like) if the image matching score is less than or equal to the respective image matching threshold (e.g., to within an error value of ±1%, ±5%, or any other number). In this manner, the authentication circuitry 210 may facilitate secondary authentication techniques in order to authenticate a target recipient before allowing the target recipient to access a respective smart mobile wallet via a recipient device (e.g., recipient device 110A). These and other operations associated with the authentication circuitry 210 will be described in further detail herein below with reference to FIGS. 3-7.

In addition, the apparatus 200 further comprises disbursement circuitry 212. In some embodiments, the disbursement circuitry 212 may be configured to facilitate the execution of one or more smart mobile wallet operations and/or transactions for a disbursing entity associated with the electronic disbursement staging system 102. Additionally, the disbursement circuitry 212 may utilize processor 202, memory 204, to perform these operations, as described in connection with FIGS. 3-7 below. The disbursement circuitry 212 may further utilize the communications hardware 206 to gather data from, or transmit data to, a variety of sources (e.g., the recipient devices 110A-110N, the user devices 112A-112N, the IA systems 114A-114N, and/or any storage devices associated with the electronic disbursement staging system 102), and/or exchange data with a target recipient, user, and/or the like. In some embodiments, the disbursement circuitry 212 may work in conjunction with the mDL management circuitry 208 and/or the authentication circuitry 210 in order to execute one or more of the methods described herein.

For example, in some embodiments, the disbursement circuitry 212 may integrate with and/or otherwise leverage the authentication circuitry 210 to facilitate the verification and/or authentication of a target recipient. In this regard, the disbursement circuitry 212 may be configured to leverage the processor 202, the memory 204, and/or the communications hardware 206 to generate, cause transmission of, and/or cause display of a plurality of interactive user interface elements on a user interface associated with a software application instance associated with the electronic disbursement staging system 102 on a recipient device 110A. The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) based on an interaction (e.g., user input) with the plurality of interactive user interface elements.

Additionally, or alternatively, the disbursement circuitry 212 may be configured to leverage the processor 202, the memory 204, and/or the communications hardware 206 to generate and/or configure (e.g., instantiate, update) a smart mobile wallet comprising one or more of a plurality of interactive user interface elements. The disbursement circuitry 212 may generate a smart mobile wallet for a target recipient, and/or the like, based on one or more recipient attributes associated with the target recipient corresponding to the target recipient stored by the disbursing entity associated with the electronic disbursement staging system 102. Additionally, the disbursement circuitry 212 may be configured to leverage the processor 202, the memory 204, and/or the communications hardware 206 to provide the smart mobile wallet to a recipient device 110A associated with the target recipient such that the target recipient is enabled to interact with and/or utilize the smart mobile wallet to execute various operations, transactions, and/or the like.

For example, based on one or more interactions with a respective smart mobile wallet, the disbursement circuitry 212 may be configured to display various digital representations and/or data related to an existing payment account, a digital payment card, a physical payment card, and/or the like via a smart mobile wallet associated with the target recipient. Additionally, or alternatively, the disbursement circuitry 212 may be configured to facilitate the configuration, reconfiguration, update and/or management of an existing payment account, a digital payment card, a physical payment card, and/or the like via a smart mobile wallet associated with the target recipient.

Additionally, based on one or more interactions with a respective smart mobile wallet, the disbursement circuitry 212 may be configured to facilitate one or more financial transactions for a target recipient. The one or more financial transactions may involve the settlement of a payment (e.g., the withdrawal and transfer of funds) initiated by a respective user with a particular disbursing entity (e.g., an online merchant, a brick-and-mortar retailer, and/or the like). In this regard, the disbursement circuitry 212 may be configured to utilize recipient account data (e.g., recipient account identifier information, recipient account routing information, and/or the like) associated with one or more means of payment (e.g., a payment card) stored in and/or associated with a smart mobile wallet of a target recipient to ensure an appropriate amount of funds is transferred from the disbursing entity to the target recipient. These and other operations associated with the disbursement circuitry 212 will be described in further detail herein below with reference to FIGS. 3-7.

Although components 202-212 are described in part using functional language, it will be understood that the particular implementations necessarily include the use of particular hardware. It should also be understood that certain of these components 202-212 may include similar or common hardware. For example, the mDL management circuitry 208, the authentication circuitry 210, and/or the disbursement circuitry 212 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the mDL management circuitry 208, the authentication circuitry 210, and/or the disbursement circuitry 212 may leverage processor 202, memory 204, and/or communications hardware 206 as described above, it will be understood that any of the mDL management circuitry 208, the authentication circuitry 210, and/or the disbursement circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the mDL management circuitry 208, the authentication circuitry 210, and/or the disbursement circuitry 212 comprise particular machinery designed for performing the functions described herein in connection with such elements of apparatus 200.

As described herein, the recipient identification data associated with a target recipient may comprise cryptographical information associated with one or more of an mDL and/or a recipient device (e.g., recipient device 110A) associated with the target recipient. In some embodiments, the cryptographical information associated with the mDL and/or the recipient device may be a public key of a public/private key pair, where the public key is provisioned to the target recipient by an IA upon issuance of the mDL. Such cryptographical information may be utilized by the electronic disbursement staging system 102 and/or an IA system (e.g., IA system 114A) associated with the IA that provisioned the mDL to identify and/or authenticate the mDL, one or more portions of desired mDL credential data, and/or the recipient device associated with the target recipient.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3-7, example flowcharts are illustrated that contain example operations implemented by example embodiments described herein. The operations illustrated in FIGS. 3-7 may, for example, be performed by server device 104 of the electronic disbursement staging system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, mDL management circuitry 208, authentication circuitry 210, disbursement circuitry 212 and/or any combination thereof. It will be understood that user interaction with the electronic disbursement staging system 102 may occur directly via communications hardware 206 or may instead be facilitated by a separate user device 112A, as shown in FIG. 1, and which may have similar or equivalent physical componentry facilitating such user interaction.

FIGS. 3-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

Turning first to FIG. 3, a procedure 300 illustrates example operations for enhancing electronic disbursement staging.

As shown by operation 302, the apparatus 200 includes means, such as processor 202, memory 204, communications hardware 206, or the like, for receiving a disbursement initiation request from a target recipient, wherein the disbursement initiation request comprises (i) disbursement data, (i) a recipient mDL, and (iii) a recipient device. For a particular disbursement event, communications hardware 206 may receive a disbursement initiation request from a recipient device (e.g., recipient device 110A) associated with a target recipient, and/or may be received from a user device (e.g., user device 112A) associated with a user affiliated with the disbursing entity. In embodiments wherein the target recipient submits the disbursement initiation request, the target recipient may use the recipient device (e.g., recipient device 110A) to submit the disbursement initiation request through a web portal associated with the disbursing entity, via a mobile application provided by the disbursing entity, and/or the like. A recipient device 110A may establish a secure connection with the disbursing entity's server using encryption protocols, such as TLS/SSL to ensure data privacy and integrity. Alternatively, the data entered by the target recipient may be packaged into a standardized format (e.g., JSON or XML) and transmitted to the server device 104 of the electronic disbursement staging system 102 via an application programming interface (API) or web service call.

In embodiments wherein a user affiliated with the disbursing entity submits the disbursement initiation request, the user may access the electronic disbursement staging system 102 through a user device (e.g., user device 112A), wherein the user inputs their secure login credentials through a web portal associated with the disbursing entity, via a mobile application provided by the entity, and/or the like. The server device 104 may authenticate the user through a single-sign-on (SSO) or other disbursing entity specific authentication methods to ensure the user seeking permission to the electronic disbursement staging system 102 have the appropriate permissions and security clearance to submit a disbursement initiation request. The disbursement initiation request initiated by the user may be transmitted securely within the internal network of the disbursing entity (e.g., through an intranet or secure API call to the backend server). The server device 104 may log the disbursement initiation request, noting the user who submitted the request and the timestamp.

Depending on the type of disbursement (e.g., funds, non-tangible resources, etc.) and purpose of disbursement (e.g., salary, invoice payment, grant), the data entry for a particular disbursement initiation request may comprise various fields. Examples of required data fields include: personal information (e.g., full name, date of birth, contact information, email address, phone number), bank account details (e.g., bank name, account number, routing number), disbursement details (e.g., amount to be disbursed, currency, purpose of disbursement, disbursement schedule), target recipient verification data (e.g., mobile driver's license, biometric data), transaction details (e.g., unique transaction identifier, reference number), recipient device data (e.g., device type and model, operating system and version, device ID or IMEI number, geolocation data, network information), and/or the like. In some embodiments, recipient device data may be automatically captured by the web portal or the mobile application through which the disbursement initiation request is submitted. In some embodiments, the target recipient may be required to scan or upload their mobile driver's license to the disbursement initiation request. Alternatively, in instances wherein the recipient device hosts a smart mobile wallet, the communications hardware 206 may automatically retrieve the mobile driver's license from the smart mobile wallet of the recipient device.

In instances where the target recipient shares an affiliative relationship with the disbursing entity (e.g., employer and employee), the disbursing entity may already possess the aforementioned exemplary data entries for the target recipient. In such cases, the apparatus 200 may access the data entries from storage device 106 and pre-populate the data entry fields for the disbursement initiation request.

In some embodiments, the disbursing entity's server may receive the disbursement initiation request, parse the incoming data fields, and perform initial validation checks (e.g., formatting, required fields), and log the disbursement initiation request in a disbursement initiation request database for tracking and auditing purposes.

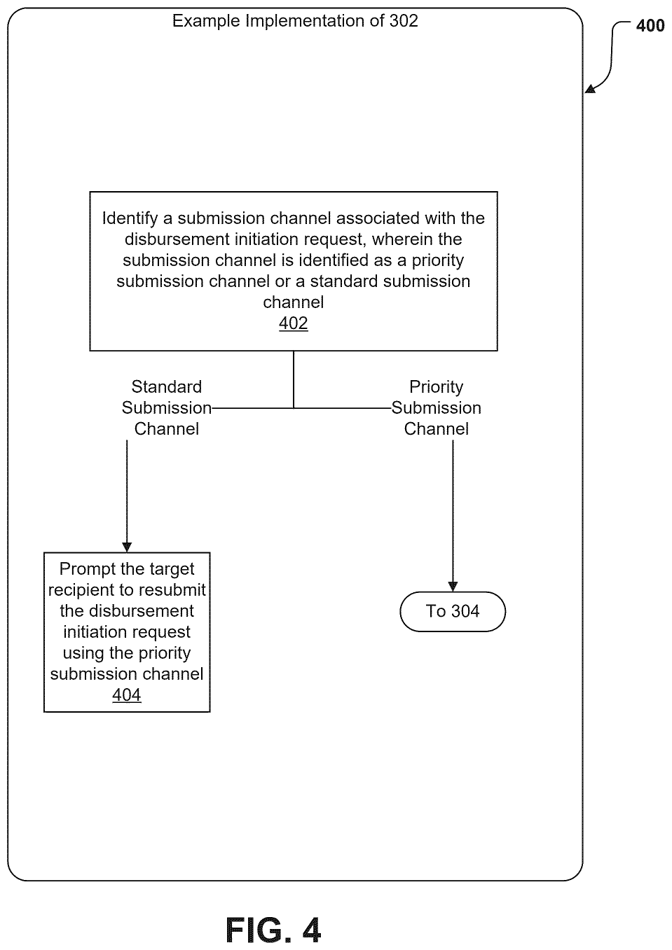

In some embodiments, operation 302 may be performed in accordance with the operations described in FIG. 4. Turning now to FIG. 4, a procedure 400 illustrates example operations for receiving a disbursement initiation request from a target recipient, wherein the disbursement initiation request comprises (i) disbursement data, (i) a recipient mDL, and (iii) a recipient device.

As shown by operation 402, the apparatus 200 includes means, such as disbursement circuitry 212, or the like, for identifying a submission channel associated with the disbursement initiation request. The disbursement circuitry 212 may utilize various technical mechanisms to track and analyze the source of the disbursement initiation request (i.e., submission channel). The disbursement initiation request may comprise identifying metadata pertinent to the identification of the submission channel. In some embodiments, the disbursement circuitry 212 may receive HTTP headers comprising identifying metadata pertaining to the recipient device 110A, browser, operating system, and/or the like making the disbursement initiation request. By parsing such HTTP headers, the disbursement circuitry 212 may identify the submission channel used for a particular disbursement initiation request. For example, the disbursement circuitry 212 may identify a user-agent header containing a string such as “User-Agent: Mozilla/5.0; Windows NT 10.0; Win 64; x64; AppleWebKit/537.36 (KHTML, like Gecko) Chrome/90.0.4430.93 Safari/537.36)”. In this case, this string indicates that the disbursement initiation request originated from a Chrome browser running on a Windows 10 desktop browser. In alternate embodiments, the disbursement circuitry 212 may use a referrer header (e.g., https://www.example.com/disbursement/form) which indicates the URL of the page that referred the request. A referrer header may provide the disbursement circuitry 212 with data pertaining to the exact page or section of a web portal from which the disbursement initiation request was submitted. In some embodiments, the disbursement circuitry 212 may parse a custom header (e.g., X-submission-channel: WebPortal), which indicates that the disbursement initiation request was submitted via the web portal.

In some embodiments, the disbursement circuitry 212 may identify custom tracking parameters (e.g., URL, request payload, HTTP headers, and/or the like) from the disbursement initiation request. In particular, the disbursement circuitry 212 may request payload parameters (e.g., “amount”: 1000, “recipientID: 12345, “submission details’: mobileApp, etc.). The disbursement circuitry 212 may extract and utilize such payload parameters to categorize and process the disbursement initiation request.

In some embodiments, when a target recipient logs into a web portal or a mobile application, the disbursement circuitry 212 may note the presence of the target recipient and/or user within the digital network of the disbursing entity and assign the target recipient a session token. The disbursement circuitry 212 may then associate each disbursement initiation request associated with the session token to track the target recipient's and/or user's interactions with the electronic disbursement staging system 102. In doing so, the disbursement circuitry 212 may identify the submission channel of the disbursement initiation request based on the target recipient's and/or user's session context.

Additionally, in some embodiments, the disbursement circuitry 212 may log every incoming disbursement initiation request with metadata (e.g., timestamp, source IP address, and submission parameters). By analyzing such logs, the disbursement circuitry 212 may infer the submission channel associated with each disbursement initiation request. In other embodiments, the disbursement circuitry 212 may utilize analytics tools or platforms to aggregate and analyze metadata of target recipient and/or user interactions with the electronic disbursement staging system 102 (e.g., by tracking the usage patterns of different submission channels and identifying trends over time). Furthermore, in some embodiments, the disbursement circuitry 212 may establish direct integrations or APIs with submission channels such as mobile applications or third-party platforms to receive additional metadata indicating the source. In alternate embodiments, should the disbursement initiation request be submitted via an external source (e.g., a referral link), the disbursement circuitry 212 may track the referral source to identify the submission channel.

Upon identifying the submission channel associated with the disbursement initiation request, the disbursement circuitry 212 may compare the identified submission channel against submission channel classification criteria as provided by a disbursing entity. A disbursing entity may prefer to receive disbursement initiation requests via priority submission channels as such channels may typically be more efficient and receive preferential processing. Examples of priority submission channels include web portals (e.g., a dedicated and secure web portal managed by the disbursing entity, where a target recipient and/or use may login to submit a disbursement initiation request), mobile applications (e.g., a proprietary mobile app developed by the disbursing entity for disbursement management), API integration (e.g., a well-documented and secure API provided by the disbursing entity for direct system-to-system disbursement requests), and/or the like. Alternatively, examples of standard submission channels include submission of disbursement initiation requests via email, a general web form, fax, third-party platforms, and/or the like. In some embodiments, the disbursement circuitry 212 may access the configuration file or a database table that lists various priority submission channels and standard submission channels. Based on the identified metadata and source of the disbursement initiation request, the disbursement circuitry may classify the submission channel as a priority submission channel or a standard submission channel. In particular, the disbursement circuitry 212 may utilize comparison logic to compare the identified submission channel against the preloaded classification criteria to determine its priority status. In instances where the submission channel does not match any predefined submission channels, the disbursement initiation request may be flagged as unknown and forwarded to a disbursing entity affiliated user for further review.

Finally, as shown by operation 404, the apparatus 200 includes means, such as communications hardware 206, or the like, for prompting the target recipient to resubmit the disbursement initiation request using the priority submission channel, in an instance in which the submission channel is identified as the standard submission channel. In such instances, the communications hardware 206 may generate a prompt that advises the target recipient and/or user to resubmit the disbursement initiation request using a disbursing entity-approved priority submission channel. The prompt may include a message highlighting the specific instructions for accessing the priority submission channel. In some embodiments, the communications hardware 206 may deliver the prompt to the recipient device 110A or user device 112A from which the disbursement initiation request was originally received (e.g., a web form, in-app notification, email, web page alert, text message, and/or the like). In some embodiments wherein the disbursement initiation request was made through a web form, the prompt may automatically redirect the target recipient and/or user to the priority web portal or mobile app download page, with instructions on how to proceed. Additionally, in some embodiments, the communications hardware 206 may capture the entries in the data fields in the original disbursement initiation request to prepopulate the corresponding data field entries for the disbursement initiation request for submission through the priority submission channel.

Returning to FIG. 3, as shown by operation 304, the apparatus 200 includes means such as mDL management circuitry 208, or the like, for verifying authenticity of the mDL based on the disbursement initiation request. Upon receiving the disbursement initiation request, the mDL management circuitry 208 may extract a recipient mDL associated with the target recipient from the disbursement initiation request. If the disbursement initiation request does not include a recipient mDL, the mDL management circuitry 208 may cause communications hardware 206 to output a notification to the recipient device 110A or the user device 112A from which the disbursement initiation request was originally received, to request the target recipient and/or user to resubmit the disbursement initiation request with the recipient mDL. The mDL management circuitry 208 may also perform the aforementioned operation in instances in which the recipient mDL in the disbursement initiation request is unreadable. In alternate embodiments, wherein the mDL management circuitry 208 detects that the recipient mDL is missing from the disbursement initiation request, the mDL management circuitry 208 may retrieve the mDL from the recipient device 110A (e.g., from a smart mobile wallet), or may retrieve the recipient mDL from a mDL database in storage device 106 of the electronic disbursement staging system 102 (e.g., in cases where the target recipient's mDL was stored for a former disbursement initiation request). Additionally, in alternate embodiments, wherein the mDL management circuitry 208 detects that the recipient mDL is missing from the disbursement initiation request and/or that the recipient mDL is corrupted, the mDL management circuitry 208 may automatically proceed to operation 314 and failover to a traditional disbursement process (e.g., cheque, e-transfer, etc.).

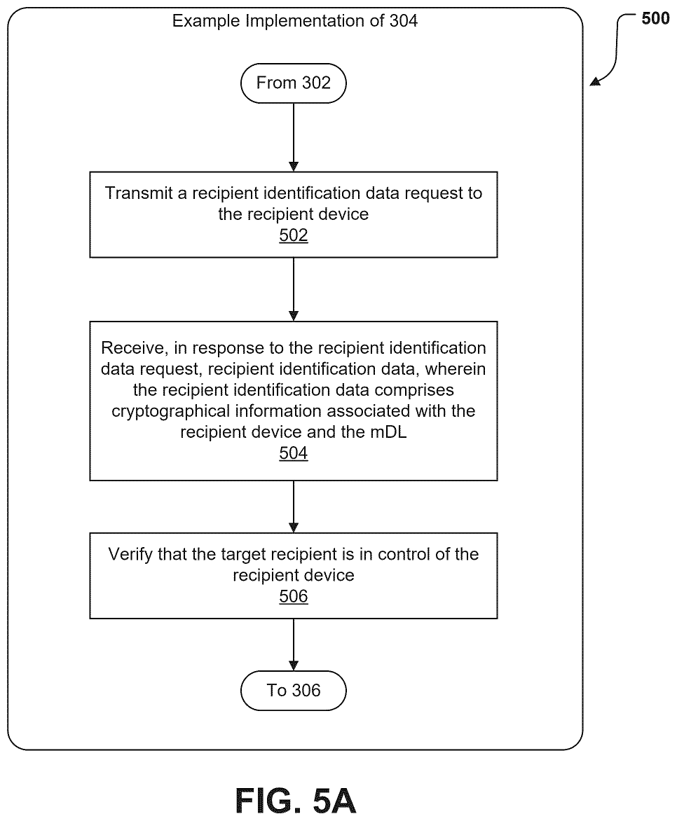

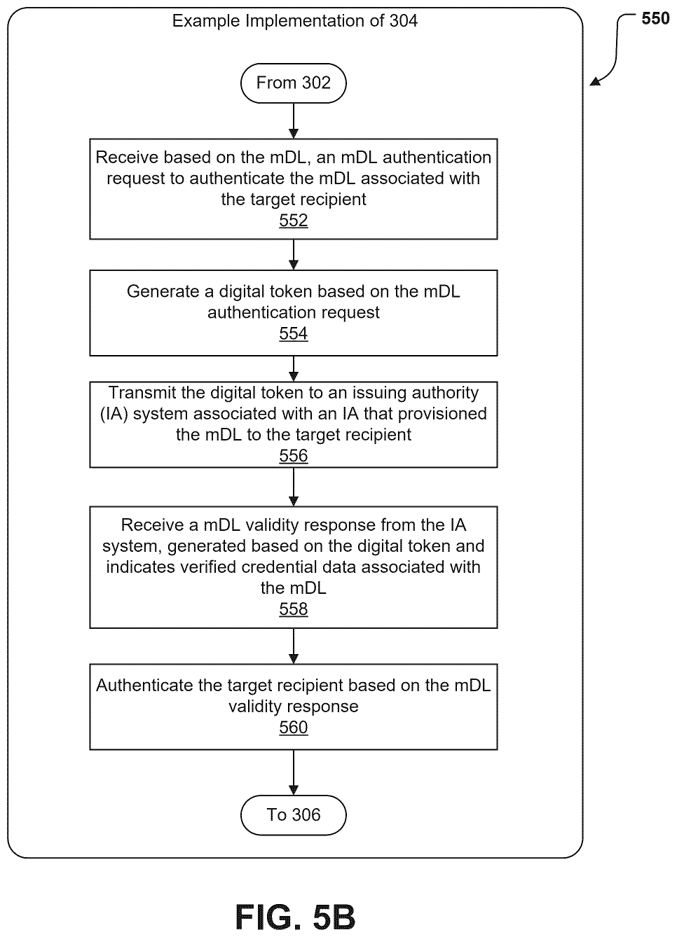

In some embodiments, operation 304 may be performed in accordance with the operations described in FIGS. 5A and 5B. Turning now to FIG. 5A, a procedure 500 illustrates example operations for verifying authenticity of the mDL based on the disbursement initiation request.

As shown by operation 502, the apparatus 200 includes means, such as mDL management circuitry 208, or the like, for transmitting a recipient identification data request to the recipient device. For example, once the mDL management circuitry 208 receives the recipient mDL associated with the target recipient, the mDL management circuitry 208 may be configured to leverage the communications hardware 206 to transmit the recipient identification data request to the recipient device 110A. In various embodiments, the recipient identification data request is a request for one or more portions of data that may be utilized to verify authenticity of the mDL. The recipient identification data request may be transmitted to the recipient device 110A through an established secure channel. Methods of transmission may include a push notification for mobile apps, an in-app message, email, SMS, and/or the like.

As shown by operation 504, the apparatus 200 includes means, such as mDL management circuitry 208, or the like, for receiving, in response to the recipient identification data request, recipient identification data, wherein the recipient identification data comprises cryptographical information associated with the recipient device and the mDL. For example, the mDL management circuitry 208 may receive the recipient identification data from the recipient device 110A based on the recipient identification data request. By way of continued example, the recipient identification data may comprise cryptographic information associated with one or more of the recipient's mDL associated with the target recipient. For instance, the recipient mDL of the target recipient may be stored by the recipient device 110A (e.g., in a smart mobile wallet), and the recipient device 110A may cause transmission of a public key associated with the mDL as part of the recipient identification data provided in response to the recipient identification data request. Additionally, or alternatively, the recipient device 110A may transmit cryptographic information (e.g., a public key) and/or other recipient identification data associated with the recipient device 110A to the apparatus 200 as part of the recipient identification data provided in response to the recipient identification data request.

Finally, as shown by operation 506, the apparatus 200 includes means, such as communications hardware 206, mDL management circuitry 208, for verifying that the target recipient is in control of the recipient device, based on the recipient identification data. To perform this verification, the mDL management circuitry 208 may capture in real-time an image of the target recipient associated with the recipient device 110A and may compare the captured image against the recipient mDL submitted as part of the disbursement initiation request. In some embodiments, the mDL management circuitry 208 may output an image capture request to the target recipient using the recipient device 110A's camera. Subsequently, the captured image may be securely transmitted from the recipient device 110A to the mDL management circuitry 208 via communications hardware 206. The mDL management circuitry 208 may perform real-time analysis and verification of the captured image using advanced facial recognition algorithms. In particular, the mDL management circuitry 208 verify facial features such as eyes, nose, mouth, overall facial structure by comparing them against the facial features present in the recipient mDL. In some embodiments, the mDL management circuitry 208 may implement anti-spoofing measures (e.g., liveness detection such as blinking and facial movements, depth analysis, etc.) to ensure authenticity of the captured image. Based on a comprehensive analysis of the aforementioned features, the mDL management circuitry 208 may verify the target recipient as being in control of the recipient device 110A, in which case subsequent operations may be performed to verify authenticity of the recipient mDL.

Turning now to FIG. 5B, a procedure 550 illustrates additional example operations for verifying authenticity of the mDL based on the disbursement initiation request.

As shown by operation 552, the apparatus 200 includes means, such as mDL management circuitry 208, or the like, for receiving an mDL authentication request, wherein the mDL authentication request is a request to authenticate the recipient mDL associated with the target recipient. Upon verifying that the target recipient is in control of the recipient device 110A, the mDL management circuitry 208 may be configured to facilitate (e.g., initiate, execute, manage) the operations of FIG. 5B in order to verify the authenticity of the recipient mDL. The mDL authentication request is a request to authenticate the mDL stored in the recipient device 110A (e.g., smart mobile wallet) associated with the target recipient. In some embodiments, the mDL authentication request may be initiated, triggered, and/or executed automatically upon verifying that the target recipient is in control of the recipient device 110A. In some embodiments, the mDL management circuitry 208 may be configured to facilitate the execution of the mDL authentication request based on one or more data features associated with the mDL authentication request. For example, in some embodiments, the mDL authentication request may comprise one or more of recipient identification data (e.g., cryptographic information associated with an mDL and/or a recipient device) associated with the target recipient, desired credential data associated with the recipient mDL (e.g., a particular request may indicate a need for verification of particular user information or personal identifying information of the target recipient, particular credential validity data, and/or the like), and/or recipient attribute data associated with the target recipient.

As shown by operation 554, the apparatus 200 includes means, such as mDL management circuitry 208, or the like, for generating a digital token based on the mDL authentication request. In some embodiments, the mDL management circuitry 208 may be configured to generate a digital token based in part on the mDL authentication request. By way of continued example, the mDL management circuitry 208 may be configured to generate a digital token comprising cryptographic information (e.g., public key information) associated with the recipient mDL of the target recipient. Additionally, in some embodiments, the cryptographic information associated with the recipient mDL and comprised in the digital token may be recipient device identification data by which a recipient device 110A of the target recipient may be uniquely identified.

As shown by operation 556, the apparatus 200 includes means, such as mDL management circuitry 208, or the like, for transmitting the digital token to an issuing authority (IA) system (e.g., IA system 114A) associated with an IA that provisioned the mDL to the target recipient. By way of continued example, the mDL management circuitry 208 may leverage the communications hardware 206 to transmit the digital token to an IA system (e.g., IA system 114A) associated with the IA that provisioned the recipient mDL to the target recipient, such that the IA system (e.g., IA system 114A) may decrypt the cryptographic information comprised in the digital token. In this manner, the IA system (e.g., IA system 114A) may verify one or more portions of credential data associated with the recipient device 110A of the target recipient.

In some embodiments, the mDL management circuitry 208 may determine that the IA that provisioned the recipient mDL may no longer be applicable to the target recipient (e.g., in situations where the target recipient has moved to a different state). In such cases, the mDL management circuitry 208 may be configured to determine the correct IA system (e.g., a different IA system) associated with the target recipient, such that the respective digital tokens generated based on respective mDL authentication requests are routed to the correct IA systems. In this manner, the electronic disbursement staging system 102 ensures the safe transmission of the respective digital tokens and the successful verification of the respective recipient mDLs, thereby verifying the target recipient.

As shown by operation 558, the apparatus 200 includes means, such as communications hardware 206, mDL management circuitry 208, or the like, for receiving a mDL validity response, wherein the mDL validity response is generated based on the digital token, and where the mDL validity response indicated verified credential data associated with the mDL. For example, the communications hardware 206 may receive the mDL validity response from the IA system (e.g., IA system 114A) associated with the IA that provisioned the mDL to the target recipient. In some embodiments, the mDL validity response is generated based on the digital token associated with the target recipient and/or the recipient device 110A associated with the target recipient. In some examples, the mDL validity response indicates verified credential data (e.g., desired credential data) associated with the mDL indicated by the mDL authentication request. Furthermore, in some examples, the mDL validity response may also indicate verified recipient device identification data related to the recipient device associated with the target recipient (e.g., recipient device 110A).

Finally, as shown by operation 560, the apparatus 200 includes means, such as mDL management circuitry 208, or the like, for authenticating the target recipient based on the mDL validity response. By way of continued example, the mDL management circuitry 208 may be configured to authenticate the recipient mDL based on the data comprised in the mDL validity response received from the IA system (e.g., one of IA systems 110A-110N). In this manner, the electronic disbursement staging system 102 may be configured to verify the authenticity of a recipient mDL associated with a target recipient.

Returning to FIG. 3, as shown by operation 314, the apparatus 200 includes means such as communications hardware 206, mDL management circuitry 208, or the like, in an instance in which the verification of the mDL authenticity indicates that the recipient mDL is inauthentic. In some embodiments, if the mDL management circuitry 208 determines that the recipient mDL is inauthentic, the mDL management circuitry 208 may be configured to generate an inauthentic mDL alert. In particular, an inauthentic mDL alert may be an alert, notification, warning, advisory, and/or the like that indicates various data related to a failed mDL authentication attempt. The inauthentic mDL alert may comprise data (e.g., recipient device identification data, timestamp data associated with the mDL authentication attempt, geolocation data associated with the target recipient during a time in which the mDL authentication attempt was executed, as indicated by GPS data collected and/or generated by a recipient device) related to a target recipient whose mDL was not successfully verified to be authentic.

In some embodiments, an inauthentic mDL alert may be configured as a notification, email, text message, direct application message (e.g., via a software application instance associated with the electronic disbursement staging system 102), audio message (e.g., automated voice message), banner notification, and/or the like. The mDL management circuitry 208 may be configured to leverage the communications hardware 206 to transmit the inauthentic mDL alert to one or more computing devices (e.g., recipient device 110A-110N, user device 112A-112N, IA systems 114A-114N, and/or the like) via a number of different communication methods over a communications network (e.g., communications network 108).

In this regard, the mDL management circuitry 208 may be configured to identify one or more individuals and/or one or more computing devices associated with said individuals to transmit the inauthentic mDL alert to. For example, the mDL management circuitry 208 may be configured to identify one or more users affiliated with the particular disbursing entity and cause transmission of the inauthentic mDL alert to the one or more user devices 112A-112N. In alternate embodiments wherein the verification of the mDL authenticity indicates that the recipient mDL is inauthentic (e.g., due to a corrupted mDL), operation 314 may failover to a traditional disbursement process to provide a payment to the target recipient. Examples of traditional disbursement processes include cheques, e-transfers, and/or the like.

In an instance in which the verification of the mDL authenticity indicates that the recipient mDL is authentic, the electronic disbursement staging system 102 may proceed to operations 306-312.

As shown by operation 306, the apparatus 200 includes means such as authentication circuitry 210, or the like, for selecting, using a risk determination machine learning model, a secondary authentication protocol, in response to verifying the authenticity of the mDL.

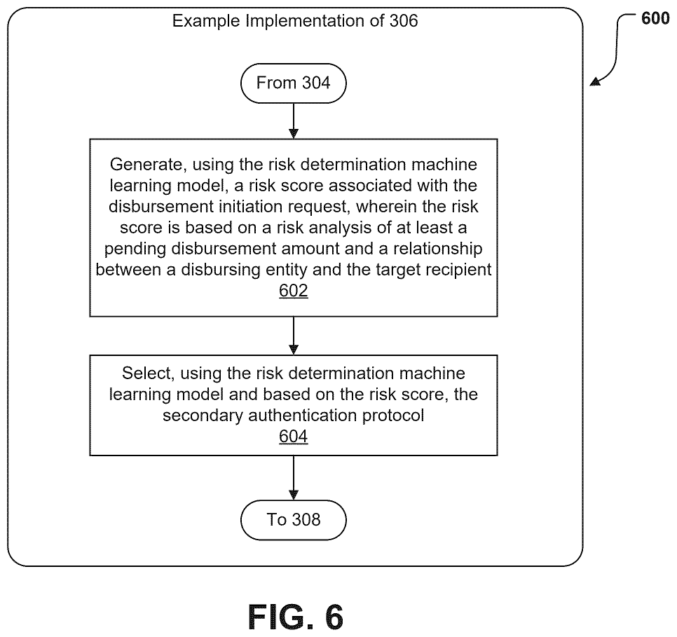

As described below, operation 306 may be performed in accordance with the operations described in FIG. 6. Turning now to FIG. 6, procedure 600 illustrates example operations 602-604 for selecting, using a risk determination machine learning model, a secondary authentication protocol, in response to verifying the authenticity of the mDL.

As shown by operation 602, the apparatus 200 includes means, such as authentication circuitry 210, or the like, for generating, using the risk determination machine learning model, a risk score associated with the disbursement initiation request, wherein the risk score is based on a risk analysis of at least a pending disbursement amount and a relationship between a disbursing entity and the target recipient. In particular, the risk determination machine learning model may process various data inputs, including financial transaction details, the nature of the relationship between the disbursing entity and the target recipient, and/or the like to generate a quantitative and/or qualitative risk score. The risk score may indicate the likelihood of fraud or error associated with a particular disbursement event, which may guide subsequent authentication and/or verification steps. For example, if target recipient A is an employee to whom the disbursing entity owes $100, the risk determination machine learning model may generate a low-risk score to indicate this disbursement event as being is relatively low risk. In an alternate example, if target recipient B is a non-employee (e.g., vendor) requesting $10,000 of disbursement, the risk determination machine learning model may generate a high score to indicate this disbursement event as being relatively high risk. The authentication circuitry 210 may extract the pending disbursement amount and relationship status between the target recipient and the disbursing entity from the disbursement initiation request. In some embodiments, the authentication circuitry 210 may extract additional details from the disbursement initiation request, the recipient device 110A, and/or the user device 112A, such as historical fraud data, disbursement frequency, geographical location of the target recipient, and/or the like. Upon extracting such details, the authentication circuitry 210 may clean, normalize, and format the extracted data to ensure compatibility with the risk determination machine learning model. In some embodiments where relevant details are missing from the disbursement initiation request, recipient device 110A, and/or user device 112A, and cannot be extracted, the authentication circuitry 210 may perform feature engineering and extract meaningful features from the raw data (e.g., “amount of disbursement”—categorical (low, medium, high) or numerical, “relationship type”—categorical (employee, contractor, customer, unknown, etc.), “historical disbursement frequency”—numerical count of previous disbursements, “disbursement recency”—time since the last disbursement, “geographical consistency”—comparison of current disbursement location with historical data”). In some embodiments, the risk determination machine learning model may be trained on available or sampled historical data with known outcomes (i.e., risk scores and corresponding risk level). For instance, a random forest classifier may be trained upon a labeled dataset comprising historical disbursement initiation requests and their associated risk scores. The trained risk determination machine learning model may then be used to generate the risk score for an ongoing disbursement initiation request.

As shown by operation 604, the apparatus 200 includes means, such as authentication circuitry 210, or the like, for selecting, using the risk determination machine learning model and based on the risk score, the secondary authentication protocol. The risk determination machine learning model may be trained upon predefined threshold for various risk scores indicative of various risk levels (e.g., low risk: 0-0.3, medium risk: 0.3-0.7, high risk: 0.7-1.0). In some embodiments, examples of secondary authentication protocols for a low-risk score include single-OTP verification (e.g., transmitting a one-time password to the recipient device 110A), password verification (e.g., simple password check or PIN entry), and/or the like. In alternate embodiments wherein the risk score is indicative of a medium level of risk, the secondary authentication protocols which may be used comprise dual-factor authentication (2FA) (e.g., combining OTP with another method of authentication such as email verification or security questions), geolocation check (e.g., verifying the recipient's current location against known locations). In some embodiments, wherein the risk score is indicative of a high-risk level, the secondary authentication protocols may comprise high risk protocols such as multi-factor authentication (e.g., using multiple layers of verification including biometrics such as fingerprint, facial recognition, OTP, and recipient-device based authentication), document verification (e.g., requiring submission of additional identity documents for review by personnel), analysis of behavioral biometrics (e.g., typing patterns, device interactions), and/or the like. In this manner, the electronic disbursement staging system 102 effectively selects and implements an appropriate secondary authentication protocol based on the generated risk score. Such a process ensures that higher-risk disbursements undergo more rigorous verification, enhancing security and reducing the likelihood of fraud. By dynamically adjusting the authentication protocol based on the anticipated risk, the electronic disbursement staging system 102 balances security measures with recipient convenience.

Returning to FIG. 3, as shown by operation 308, the apparatus 200 includes means such as communications hardware 206, authentication circuitry 210, or the like, for authenticating the target recipient based on the secondary authentication protocol. In some embodiments, the authentication circuitry 210 may initiate the selected secondary authentication protocol by communicating with a recipient device 110A via communications hardware 206. Based on the provided authentication data, the authentication circuitry 210 may verify the provided authentication data against the expected value. For instance, if an OTP was transmitted to the recipient device 110A, the authentication circuitry 210 may verify the OTP by comparing the entered OTP with the generated OTP. In the instance the entered OTP and the generated OTP match, the secondary authentication may be considered successful.

In some embodiments, the authentication circuitry 210 may authenticate the target recipient based on the recipient attribute data, in an instance in which a disbursing entity retained recipient attribute data for the disbursement event. In some embodiments, the disbursing entity may possess preexisting recipient attribute data associated with the target recipient. For example, if the target recipient is a recurring recipient to whom the disbursement entity owes disbursements, the disbursing entity may have the corresponding recipient attribute data stored in storage device 106. In such cases, the authentication circuitry 210 may perform an additional verification of the target recipient by cross-checking the disbursement data, provided as part of the disbursement initiation request against the stored recipient attribute data. For example, the authentication circuitry 210 may compare the current disbursement amount against historical disbursement amounts to detect anomalies. Should an anomaly be present, the authentication circuitry 210 may be further configured to flag the anomaly, generate a corresponding alert, and forward the alert to the user affiliated with the disbursing entity for further review.

Returning to FIG. 3, as shown by operation 310, the apparatus 200 includes means such as communications hardware 206, disbursement circuitry 212, or the like, for retrieving disbursement preference data from the recipient device. In some embodiments, the disbursement circuitry 212, in conjunction with communications hardware 206 may securely retrieve disbursement preference data (e.g., bank account details) from a recipient device 110A and transmit the disbursement preference data to the internal system (e.g., server) of the disbursing entity. In some embodiments, the disbursement circuitry 212 may initiate this operation by ensuring that a secure communication channel is established between the recipient device 110A and the internal system (e.g., server) of the disbursing entity using HTTPS. Subsequently, the disbursement circuitry 212 may transmit a request to the recipient device 110A for disbursement preference data. The request may comprise a unique transaction identifier, a request for specific data fields (e.g., bank account number, routing number, preferred payment method, consent to storage of the bank account details, and/or the like). The recipient device 110A may display a secure form or application interface prompting the target recipient to enter their disbursement preference data (e.g., bank account number, routing number, preferred payment method such as direct deposit or digital wallet). In some embodiments, the recipient device 110A may encrypt the disbursement preference data using a strong encryption algorithm (e.g., AES-256) to ensure data security during transmission. The encrypted disbursement preference data may be transmitted back to the internal system (e.g., server) of the disbursing entity through the previously established communication channel. Upon receiving the encrypted disbursement preference data, the disbursement circuitry 212 may decrypt the received disbursement preference data using a corresponding decryption key, restoring the original disbursement preference data provided by the target recipient. In some embodiments, the decrypted disbursement preference data may be stored securely in the disbursing entity's database (e.g., storage device 106). Access to the aforementioned database may be restricted to authorized users, personnel, and systems.

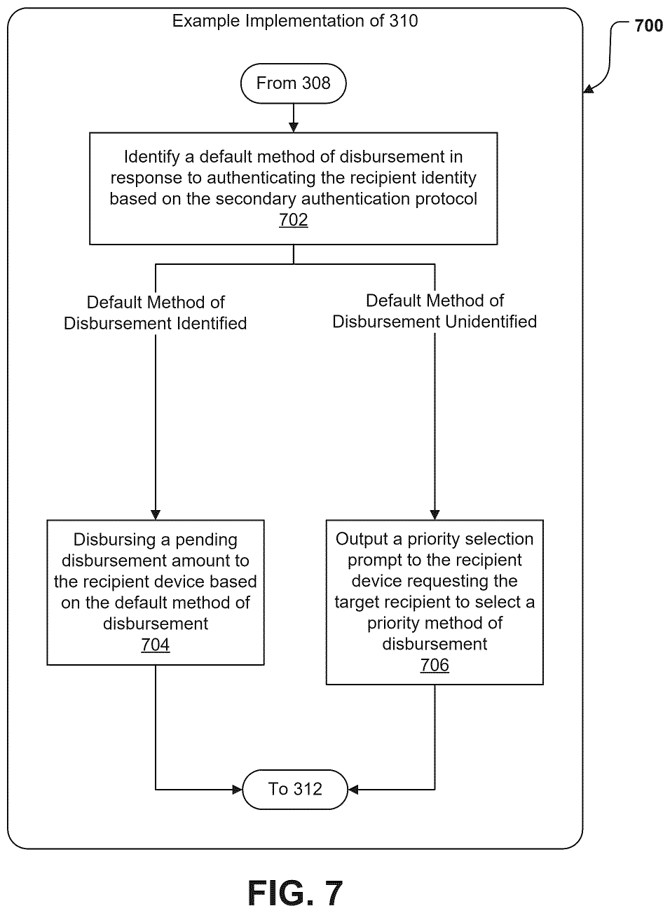

In some embodiments, operation 310 may be performed in accordance with the operations described in FIG. 7. Turning now to FIG. 7, a procedure 700 illustrates example operations for staging a disbursement event using the disbursement preference data.

As shown by operation 702, the apparatus 200 includes means such as disbursement circuitry 212, or the like, for identifying a default method of disbursement in response to authenticating the target recipient based on the secondary authentication protocol. In some embodiments, the disbursement circuitry 212 may not output a disbursement preference data request and may automatically identify the default method of disbursement preferred by the target recipient. This may be particularly applicable to scenarios wherein a target recipient is a recurring recipient to whom the disbursing entity owes disbursements. In such cases, to ensure that funds are correctly disbursed, the disbursement circuitry 212 may retrieve historical disbursement records from the internal database of the disbursing entity for a particular target recipient. The historical disbursement records may comprise data such as previous disbursements, payment methods used, and any other preferences indicated by the target recipient. In some embodiments, the disbursement circuitry 212 may examine the target recipient's profile, including frequency of disbursements, previously used disbursement methods, and any additional stored recipient attribute data that may provide insights into their default method of disbursement. Based on this examination of the target recipient's profile, the disbursement circuitry 212 may identify the most commonly used disbursement method (e.g., direct deposit, digital wallet, cheque, and/or the like). In some embodiments, the disbursement circuitry 212 may use predefined rules and policies set by the disbursing entity to determine the default method of disbursement. Examples of predefined rules include frequency of method usage, compliance and security requirements, and target recipient preferences. Further, the disbursement circuitry 212 may validate the default method of disbursement against current target recipient data to ensure that the default method of disbursement is valid and applicable (e.g., checking if the bank account associated with the default method of disbursement is active). In some embodiments, the disbursement circuitry 212 may transmit a confirmation request to the recipient device 110A to allow the target recipient to confirm the default method of disbursement.

As shown by operation 704, the apparatus 200 includes means such as disbursement circuitry 212, or the like, for disbursing a pending disbursement amount to the recipient device based on the default method of disbursement. Upon identifying the default method of disbursement, the disbursement circuitry 212 may proceed with disbursing the pending disbursement amount as indicated in the disbursement initiation request. In some embodiments, depending on the selected method (e.g., ACH transfer, digital wallet, etc.), the disbursement preference data may be formatted into the required structure and encoding to ensure compatibility with the corresponding financial network. The disbursement circuitry 212 may transmit the formatted disbursement instructions to the appropriate financial network or payment gateway by securely sending the associated data through established protocols (e.g., HTTPS, API calls, or direct bank interfaces). To protect data during transmission, the disbursement circuitry 212 may use encryption (e.g., TLS/SSL) and secure authentication methods (e.g., API keys, OAuth tokens). Once the financial network or payment gateway processes the transfer, the disbursement circuitry 212 may receive a confirmation response indicating the status of the disbursement (e.g., success, pending, failure). In some embodiments, the disbursement circuitry 212 may log all transaction details, including timestamps, status, and confirmation numbers for record-keeping, audit, and compliance purposes.

As shown by operation 706, the apparatus 200 includes means such as communications hardware 206, or the like, for outputting a priority selection prompt to the recipient device, in an instance in which the default method of disbursement is not identified, wherein the priority selection prompt requests the target recipient to select a priority method of disbursement. In some embodiments, the disbursement circuitry 212 may not output a disbursement preference data request and may automatically identify the default method of disbursement preferred by the target recipient. This may be particularly applicable to scenarios wherein a target recipient is a recurring recipient to whom the disbursing entity owes disbursements. In such cases, to ensure that funds are correctly disbursed, the disbursement circuitry 212 may retrieve historical disbursement records from the internal database of the disbursing entity for a particular target recipient. The historical disbursement records may comprise data such as previous disbursements, payment methods used, and any other preferences indicated by the target recipient. However, if the historical disbursement records do not comprise data related to a payment method, the disbursement circuitry 212 may dynamically generate a prompt message that requests the target recipient to select a priority method of disbursement. The communications hardware 206 may be configured to transmit the generated prompt message to a recipient device 110A (e.g., via SMS, email, push notification, or through an in-app message system. In some embodiments, the communications hardware may monitor incoming messages or responses from the recipient device 110A to identify the priority method of disbursement. Upon receiving the target recipient's priority method of disbursement, the disbursement circuitry 212 may validate the recipient's priority method of disbursement to ensure that it is feasible and compliant with the policies and procedures of the disbursing entity and may further verify if the selected method is supported by the internal system of the disbursing entity. Once validated, the disbursement circuitry 212 may proceed to operation 312 for staging a disbursement event using the disbursement preference data.

Returning to FIG. 3, as shown by operation 312, the apparatus 200 includes means such as communications hardware 206, disbursement circuitry 212, or the like, for staging a disbursement event using the disbursement preference data. In some embodiments, the disbursement circuitry 212 may validate the received disbursement preference data against the disbursement initiation request to ensure consistency and accuracy. The disbursement circuitry 212 may then initiate staging of the disbursement event based on the provided disbursement preference data. For instance, the disbursement circuitry 212 may use the bank account number and routing number to automatically initiate an ACH transfer or another payment method as specified by the target recipient. In alternate embodiments, the disbursement circuitry 212 may forward the received disbursement preference data to a user device 112A, wherein a user affiliated with the disbursing entity may perform a final approval of the disbursement.

Additionally, in some embodiments, the disbursement preference data may include a priority method of disbursement. Upon receiving details regarding the priority method of disbursement, the disbursement circuitry 212 may proceed with disbursing the pending disbursement amount to the priority method of disbursement. In some embodiments, depending on the selected method (e.g., ACH transfer, digital wallet, etc.), the disbursement preference data may be formatted into the required structure and encoding to ensure compatibility with the corresponding financial network. The disbursement circuitry 212 may transmit the formatted disbursement instructions to the appropriate financial network or payment gateway by securely sending the associated data through established protocols (e.g., HTTPS, API calls, or direct bank interfaces). To protect data during transmission, the disbursement circuitry 212 may use encryption (e.g., TLS/SSL) and secure authentication methods (e.g., API keys, OAuth tokens). Once the financial network or payment gateway processes the transfer, the disbursement circuitry 212 may receive a confirmation response indicating the status of the disbursement (e.g., success, pending, failure). In some embodiments, the disbursement circuitry 212 may log all transaction details, including timestamps, status, and confirmation numbers for record-keeping, audit, and compliance purposes.

In addition, the disbursement circuitry 212 may provide a confirmation to the recipient via a secure communication channel (e.g., email, SMS) indicating that the disbursement has been completed. In some embodiments, the disbursement circuitry 212 may log the disbursement details and update the disbursement transaction status in the internal database of the electronic disbursement staging system 102 for record-keeping, audit, and compliance purposes.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable efficient authentication of target recipients during a disbursement event. Example embodiments thus provide tools that overcome the problems faced by conventional electronic disbursement mechanisms and techniques. By avoiding the use of conventional electronic disbursement mechanisms and techniques, example embodiments thus save time and resources, while also eliminating the need for manual verification and authentication of target recipients. Moreover, embodiments described herein counter a wide range of emerging risks in an evolving technological landscape.

For instance, by utilizing mDLs to authenticate target recipients for a disbursement event, example embodiments provide protection against the loss, theft, and/or misuse of conventional forms of disbursement (e.g., cash, cheques, etc.) where funds may easily be misdirected. As such, by streamlining and automating the authentication process for a disbursement event, resources and material costs are significantly lowered for disbursing entities (e.g., financial entities). Example embodiments also reduce the technical complexity of requiring manual verification and authentication of target recipients. As such, example embodiments provide additional layers of security to ensure the safe disbursement of funds.

Moreover, example embodiments contemplated herein provide technical solutions that solve real-world problems faced by disbursing entities who wish to safely disburse funds to potentially unknown recipients (e.g., contract workers providing their services to a disbursing entity) by employing various mDL-based user authentication techniques. While confirming the identity of a recipient has been a technical challenge several years, the increasing number of self-employed individuals using online-based marketing tools, online classifieds, and/or service aggregation websites has made this problem significantly more acute, especially as identity fraud and impersonation techniques become more sophisticated. By utilizing a legally issued mDL to authenticate a target recipient, embodiments of the present disclosure ensure that target recipients are properly verified before the disbursement of funds, thereby increasing the security and safety of the disbursement process.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for using a mobile driver's license (mDL) to enhance electronic disbursement staging, the method comprising:
receiving, by communications hardware, a disbursement initiation request from a target recipient, wherein the disbursement initiation request comprises (i) disbursement data, (ii) a recipient mDL, and (iii) a recipient device;
verifying, by mDL management circuitry and based on the disbursement initiation request, authenticity of the mDL;
in response to verifying the authenticity of the mDL:
selecting, by authentication circuitry and using a risk determination machine learning model, a secondary authentication protocol, and
authenticating, by the authentication circuitry and based on the secondary authentication protocol, the target recipient;
receiving, by the communications hardware and from the recipient device, disbursement preference data; and
staging, by disbursement circuitry, a disbursement event using the disbursement preference data.

2. The method of claim 1, wherein receiving the disbursement initiation request further comprises:
identifying, by the disbursement circuitry, a submission channel associated with the disbursement initiation request, wherein the submission channel is identified as a priority submission channel or a standard submission channel; and
in an instance in which the submission channel is identified as the standard submission channel:
prompting, by the communications hardware, the target recipient to resubmit the disbursement initiation request using the priority submission channel.

3. The method of claim 1, further comprising:
transmitting, by the mDL management circuitry, a recipient identification data request to the recipient device;
receiving, by the mDL management circuitry and in response to the recipient identification data request, recipient identification data, wherein the recipient identification data comprises cryptographical information associated with the recipient device and the mDL; and
verifying, by the mDL management circuitry and based on the recipient identification data, that the target recipient is in control of the recipient device.

4. The method of claim 1, further comprising:
receiving, by the mDL management circuitry and based on the mDL, an mDL authentication request, wherein the mDL authentication request is a request to authenticate the mDL associated with the target recipient;
generating, by the mDL management circuitry and based on the mDL authentication request, a digital token;
transmitting, by the mDL management circuitry, the digital token to an issuing authority (IA) system associated with an IA that provisioned the mDL to the target recipient;
receiving, by the mDL management circuitry and from the IA system, a mDL validity response, wherein the mDL validity response is generated based on the digital token, and where the mDL validity response indicates verified credential data associated with the mDL; and
authenticating, by the mDL management circuitry, the target recipient based on the mDL validity response.

5. The method of claim 4, wherein the mDL authentication request comprises one or more of recipient identification data, credential data associated with the mDL, or recipient attribute data associated with the target recipient.

6. The method of claim 5, further comprising:
in an instance in which a disbursing entity retained the recipient attribute data for the disbursement event:
authenticating, by the authentication circuitry and based on the recipient attribute data, the target recipient.

7. The method of claim 1, wherein selecting the secondary authentication protocol further comprises:
generating, by the authentication circuitry and using the risk determination machine learning model, a risk score associated with the disbursement initiation request, wherein the risk score is based on a risk analysis of at least a pending disbursement amount and a relationship between a disbursing entity and the target recipient;
selecting, by the authentication circuitry and using the risk determination machine learning model, and based on the risk score, the secondary authentication protocol; and
authenticating, by the authentication circuitry and based on the secondary authentication protocol, the target recipient.

8. The method of claim 1, further comprising:
in response to authenticating the target recipient based on the secondary authentication protocol:
identifying, by the disbursement circuitry, a default method of disbursement; and
disbursing, by the disbursement circuitry and based on the default method of disbursement, a pending disbursement amount to the recipient device.

9. The method of claim 8, further comprising:
outputting, by the communications hardware, and in an instance in which the default method of disbursement is not identified, a priority selection prompt to the recipient device, wherein the priority selection prompt requests the target recipient to select a priority method of disbursement; and
disbursing, by the disbursement circuitry, the pending disbursement amount to the priority method of disbursement.

10. An apparatus for using a mobile driver's license (mDL) to enhance electronic disbursement staging, the apparatus comprising:
communications hardware configured to receive a disbursement initiation request from a target recipient, wherein the disbursement initiation request comprises (i) disbursement data, (ii) a recipient mDL, and (iii) a recipient device;
mDL management circuitry configured to:
verify, based on the disbursement initiation request, authenticity of the mDL; authentication circuitry configured to:
in response to verifying the authenticity of the mDL:
select, using a risk determination machine learning model, a secondary authentication protocol, and
authenticate, based on the secondary authentication protocol, target recipient;
wherein the communications hardware is further configured to:
receive disbursement preference data from the recipient device; and
disbursement circuitry is configured to:
stage a disbursement event using the disbursement preference data.

11. The apparatus of claim 10, wherein the disbursement circuitry is further configured to:
identify a submission channel associated with the disbursement initiation request, wherein the submission channel is identified as a priority submission channel or a standard submission channel;
wherein the communications hardware is further configured to:
in an instance in which the submission channel is identified as the standard submission channel, prompt the target recipient to resubmit the disbursement initiation request using the priority submission channel.

12. The apparatus of claim 10, wherein the mDL management circuitry is further configured to:
transmit a recipient identification data request to the recipient device;
receive, in response to the recipient identification data request, recipient identification data, wherein the recipient identification data comprises cryptographical information associated with the recipient device and the mDL; and
verify, based on the recipient identification data, that the recipient device is in control of the target recipient.

13. The apparatus of claim 10, wherein the mDL management circuitry is further configured to:
receive, based on the mDL, an mDL authentication request, wherein the mDL authentication request is a request to authenticate the mDL associated with the target recipient;
generate, based on the mDL authentication request, a digital token;
transmit the digital token to an issuing authority (IA) system associated with an IA that provisioned the mDL to the target recipient;
receive, from the IA system, a mDL validity response, wherein the mDL validity response is generated based on the digital token, and where the mDL validity response indicates verified credential data associated with the mDL; and
authenticate the target recipient based on the mDL validity response.

14. The apparatus of claim 13, wherein the mDL authentication request comprises one or more of recipient identification data, credential data associated with the mDL, or recipient attribute data associated with the target recipient.

15. The apparatus of claim 14, wherein the authentication circuitry is further configured to:
in an instance in which a disbursing entity retained the recipient attribute data for the disbursement event:
authenticate, based on the recipient attribute data, the target recipient.

16. The apparatus of claim 10, wherein the authentication circuitry is further configured to:
generate, using the risk determination machine learning model, a risk score associated with the disbursement initiation request, wherein the risk score is based on a risk analysis of at least a pending disbursement amount and a relationship between a disbursing entity and the target recipient;
select, using the risk determination machine learning model, and based on the risk score, the secondary authentication protocol; and
authenticate, based on the secondary authentication protocol, the target recipient.

17. The apparatus of claim 10, wherein the disbursement circuitry is further configured to:
in response to authenticating the target recipient based on the secondary authentication protocol:
identify a default method of disbursement; and
disburse, based on the default method of disbursement, a pending disbursement amount to the recipient device.

18. The apparatus of claim 17, wherein the communications hardware is further configured to:
output, in an instance in which the default method of disbursement is not identified, a priority selection prompt to the recipient device, wherein the priority selection prompt requests the target recipient to select a priority method of disbursement,
wherein the disbursement circuitry is further configured to:
disburse the pending disbursement amount to the priority method of disbursement.

19. A computer program product for using a mobile driver's license (mDL) to enhance electronic disbursement staging, the computer program product comprising at least one non-transitory computer readable storage medium storing software instructions that, when executed, cause an apparatus to:
receive, from a target recipient, a disbursement initiation request identifying (i) disbursement data, (ii) a recipient mDL, and (iii) a recipient device;
verify, based on the disbursement initiation request, authenticity of the mDL; and
in response to verifying the authenticity of the mDL:
select, using a risk determination machine learning model, a secondary authentication protocol,
authenticate, based on the secondary authentication protocol, the target recipient,
receive, from the recipient device, disbursement preference data, and
stage a disbursement event using the disbursement preference data.

20. The computer program product of claim 19, wherein the software instructions, when executed, further cause the apparatus to:
receive, based on the mDL, an mDL authentication request, wherein the mDL authentication request is a request to authenticate the mDL associated with the target recipient;
generate, based on the mDL authentication request, a digital token;
transmit the digital token to an issuing authority (IA) system associated with an IA that provisioned the mDL to the target recipient;
receive, from the IA system, a mDL validity response, wherein the mDL validity response is generated based on the digital token, and where the mDL validity response indicates verified credential data associated with the mDL; and
authenticate the target recipient based on the mDL validity response.
